(19) United States
(12) Patent Application Publication
(10) Pub. No.: US 2011/0140010 A1
(43) Pub. Date: Jun. 16, 2011

(54) Method and Device for Detecting an Undesirable Object or Flaw

(76) Inventors: Peter Jensen Akkerman, Huizen (NL); Dan Van Der Meer, Delft (NL); Sjoerd Van Der Zwaan, Eemnes (NL); Frederik Nico Endtz, Rotterdam (NL); Arend Van De Stadt, Huizen (NL)

(21) Appl. No.: 12/301,444

(22) PCT Filed: May 21, 2007
(86) PCT No.: PCT/NL07/00132

§ 371 Date: Apr. 28, 2009

(30) Foreign Application Priority Data
May 22, 2006 (NL) 1031853

(51) Int. Cl. G01N 21/90

(52) U.S. Cl. 250/553; 250/216; 250/453.11

(57) ABSTRACT

Method for detecting an undesired object or flaw in relation to a background, wherein radiation with a first characteristic is cast by a first radiation source onto and close to the background and the location where the undesired object or flaw is to be expected, wherein radiation generated by the radiation source and reflected, dispersed, diffracted or transmitted by the undesired object is sensed by one or more radiation sensors, and wherein radiation is cast onto the location by a second radiation source with a second characteristic, which is disposed and/or has a second radiation characteristic such that apparent flaws can be removed relatively easily from the image signal sensed by the sensors.

Automatic optical inspection is applied in many fields. A number of examples relate to detecting the position of bread rolls such as croissants on a conveyor belt, recognising suitcases, backpacks, domestic pets and the like on a conveyor belt in an airport. This optical inspection is applied particularly in the case of product carriers such as bottles and cans with foodstuffs for the purpose of monitoring the quality of the packaging and the integrity of the product. In addition to beer bottles, this also relates to for instance cans with powder and other food products. The shape of bottles and packages must usually also be detected, in particular if they are non-round or otherwise angular.

It is particularly important in the food industry that flawed product carriers are removed during the production process. Automatic inspection is more appropriate than manual inspection in order to prevent consumer claims, while the efficiency is also improved.

In optical detection, candidate flaws, i.e. ‘real’ and ‘false’ flaws, are usually made visible in an image or series of images, or pixels of the product carrier. One or more light sources and cameras are generally applied for the optical detection.

After the optical detection the candidate flaws are filtered. On the basis of the different settings and filtering operations it is decided whether a candidate flaw is a so-called ‘real’ flaw or a ‘false’ flaw. In the filtering operations the final rejection from the system is determined which, in addition to real flaws, can still comprise false flaws. The filtering operations usually make use of software and computers.

When the sensitivity of the optical detection is increased, more false flaws will generally also occur. In the filtering operations the real flaws must then be selected as well as possible.

In the removal of the false flaws from the selection so as to prevent undesired rejection, the setting will have to be sensitive, whereby real flaws will not be rejected either.

In recent years, inspection systems have been incorporated in the production environment in beer breweries. These detect contamination or glass particles in a filled or unfilled bottle. This contamination and these glass particles are usually situated in the bottle at the bottom of the bottle or on the inner side of the side wall. In order to make these particles visible, use is made of illumination and cameras situated outside the bottle. Due to embossing, decorations and coding and the like arranged on the bottle, on or in the glass of the bottle, or labelling, as well as moisture and foam on the outside of the bottle, and reflections via belts, guiding etc., additional candidate flaws will be generated which are false. In some cases this can result in an undesired rejection of up to 50% of the total rejection. A false reject of 0.05% of the passing products is the maximum permissible percentage in practice, while the false accept may be no more than 0.5% of the passing products, in case of undesired particles in beer bottles.

If the optical system is set to be less sensitive or the filtering system is set to be more sensitive in order to reduce the undesired rejection, the false accept, i.e. allowing through bottles or other objects with flaws, will increase.

It is an object of the present invention to improve the prior art, particularly in respect of false reject and false accept.

The present invention provides a method for detecting an undesired object or flaw in relation to a background, wherein radiation with a first characteristic is cast by a first radiation source onto and close to the background and the location where the undesired object or flaw is to be expected, wherein radiation generated by the radiation source and reflected, dispersed, diffracted or transmitted by the undesired object is sensed by one or more radiation sensors, and wherein radiation is cast onto the location by a second radiation source with a second characteristic, which is disposed and/or has a second radiation characteristic such that apparent flaws can be removed relatively easily from the image signal sensed by the sensors.

By making a distinction between background object and flaw, for instance through the angle of incidence of the radiation, the polarization direction of the radiation, the interaction between background object and radiation, and/or the colour of the radiation with the second characteristic, backgrounds which produce false flaws can be illuminated differently than the real flaws, and the false flaws can be distinguished in the optical system and/or the later system-based filtering.

The embodiment recommended here relates to the use of red light for optical inspection of a bottle of for instance green or brown glass, while blue light is radiated along the bottle as a type of (net) curtain and, partly due to the colour and the direction, penetrates less into the glass so that the cameras, one or more of which are optionally also provided with optical filters such as for instance a colour filter or a polarization filter, receive different images which together produce a better result.

Although the present invention can be applied very readily for filtering out reflections on ridges in a can or background radiation on a conveyor belt, the preferred embodiment relates to the detection of undesired particles such as a glass splinter in a bottle.

The present invention further provides devices for detecting an undesired object or flaw in relation to a background, wherein radiation with a first characteristic is cast by a first radiation source onto and close to the background and the location where the undesired object or flaw is to be expected, wherein radiation generated by the radiation source and reflected, dispersed, diffracted or transmitted by the undesired object is sensed by one or more radiation sensors and wherein radiation is cast onto the location by a second radiation source with a second characteristic, which is disposed and/or has a second radiation characteristic such that apparent flaws can be removed relatively easily from the image signal sensed by the sensors, in which devices the preferred embodiment of the invention is implemented.

Further advantages, features and details of the present invention will be shown on the basis of the following description, in which reference is made to the accompanying drawing, in which:

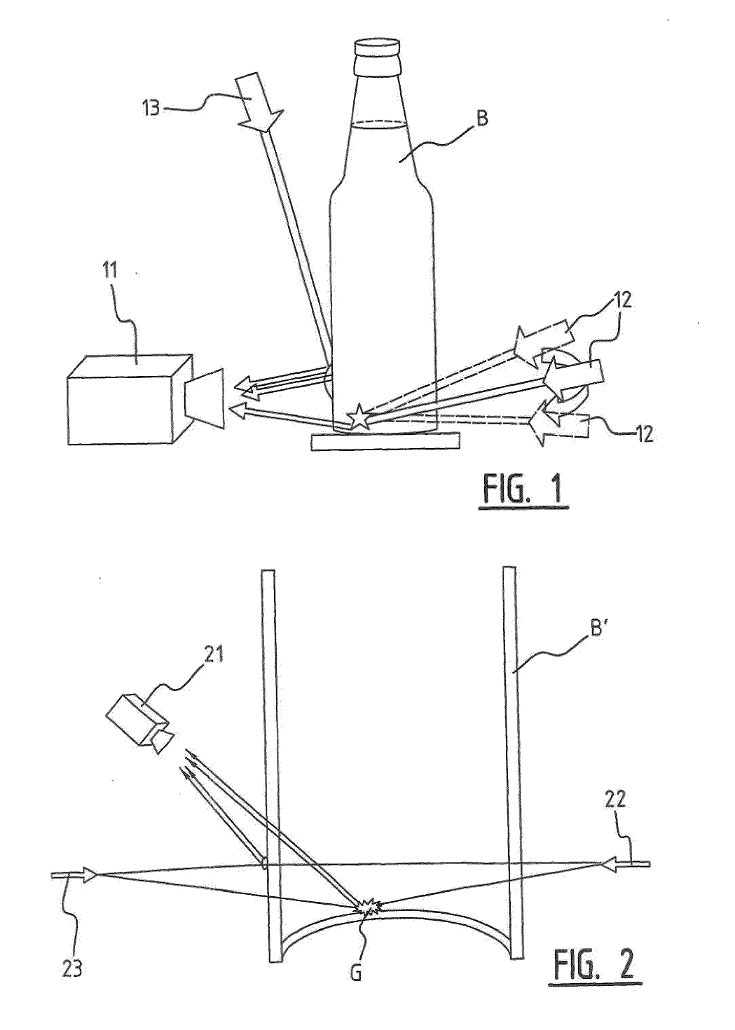

FIG. 1 shows a schematic view of a first preferred embodiment of a device according to the present invention;

FIG. 2 shows a schematic cross-sectional view of a second preferred embodiment;

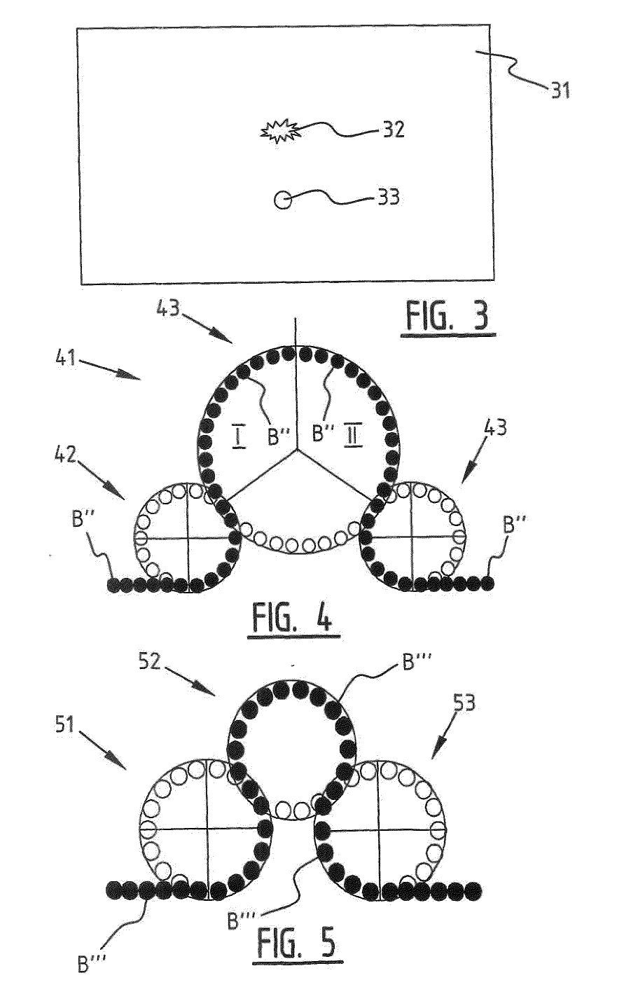

FIG. 3 shows a schematic view of a possible image from the embodiments of FIGS. 1 and 2;

FIG. 4 shows a schematic top view of a further preferred embodiment of a device according to the present invention;

FIG. 5 shows a schematic top view of another preferred embodiment in which a method according to the present invention can be applied;

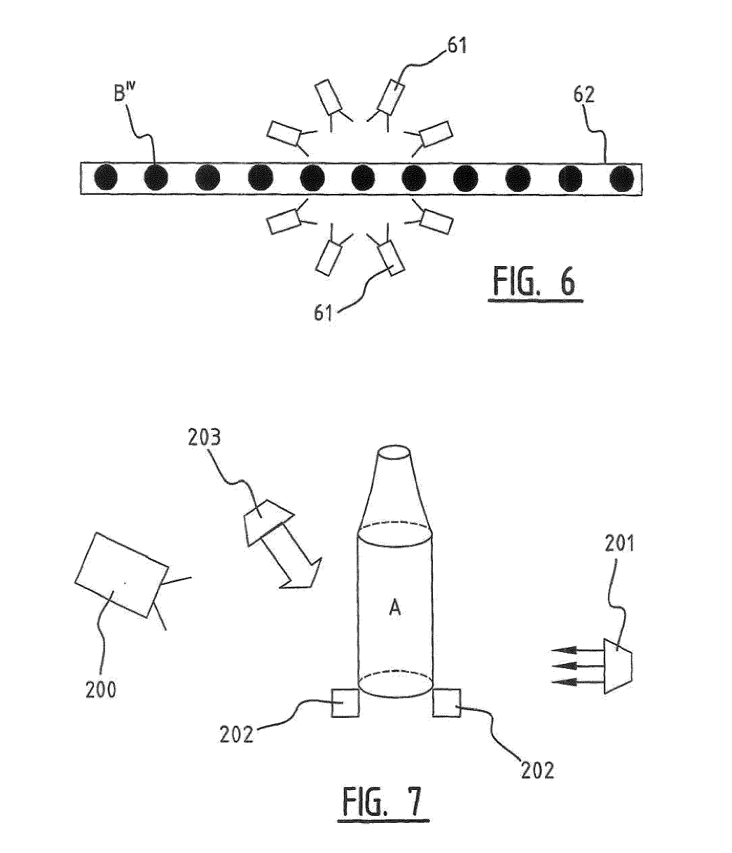

FIG. 6 shows a schematic top view of a further preferred embodiment in which the method according to the present invention can be applied;

FIGS. 7, 8 and 9 are respectively schematic views elucidating the preferred embodiment shown in FIG. 4, 5 or 6; and

FIG. 10 shows a schematic view of yet another preferred embodiment of the present invention.

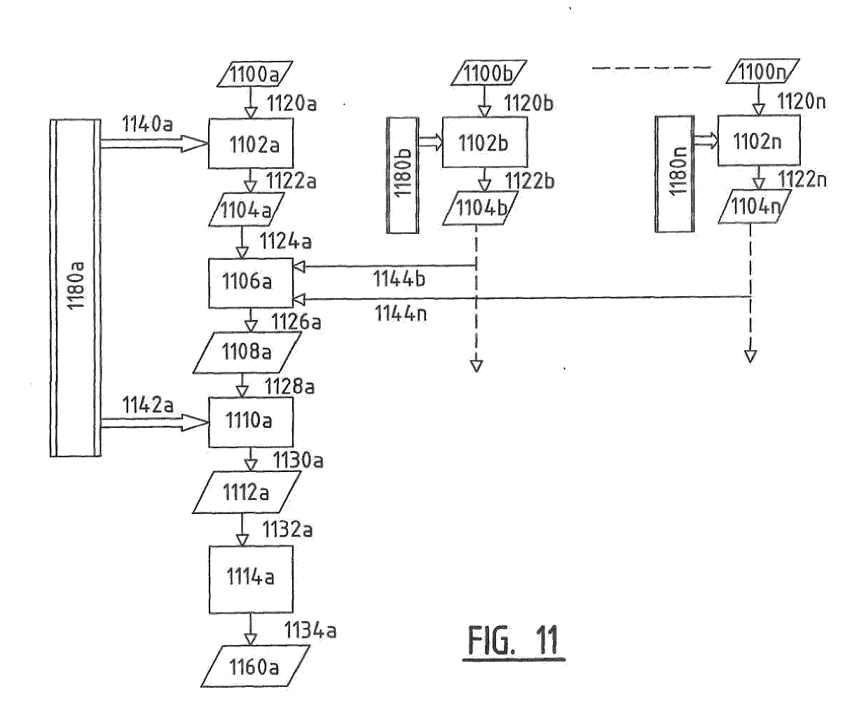

FIG. 11 shows a data flow diagram of an embodiment according to the present invention.

A beer bottle B (FIG. 1) can be provided on the outside with embossing, i.e. a relief for the purpose of indicating a brand or the like, as well as a more or less transparent, stuck-on label or printed label. In order to detect possible glass splinters in bottle B a camera 11 is disposed close to the bottom thereof, while one or more light sources 12 are disposed opposite. These light sources preferably have the colour red in a wavelength range of 550-780 μm so that the light shines through the bottle well. Owing to the addition of a second light source 13, which radiates light of the colour blue substantially along the bottle, the false flaws are additionally illuminated. This so-called light curtain does not illuminate the particles to be detected in the bottle (or hardly so) due to the different angle and/or colour and/or low transmission of the second radiation through the bottle.

In bottle B^{I} (FIG. 2) is situated a glass particle G which must be detected by camera 21. The main illumination 22 of the red colour illuminates both the glass particle in the bottle and irregular embossing on the outside of the bottle, which is undesirable. By applying a second illumination 23 of the blue colour, substantially the outer side of the bottle is illuminated in the blue colour, whereby the irregularities on the outside of the bottle, such as embossing and the like, become easily visible. About 90% of the red beams directed at the camera are transmitted by a bottle at each passage, while only about 10% of the blue colour will be transmitted due to transmission properties of the bottle.

Depending on the colour of the bottle, other wavelengths can of course also be selected in order to optimize the different transmissions for the colours.

In FIG. 3 the glass particle in a camera image 31 is designated with 32, while an undesired flaw, such as embossing, is designated with 33. Particle 32 will have 81% of the original intensity of the red light (at full reflection) and only 1% of the intensity of the blue light, while the embossing on the side of the blue light has a reflection value of about 80 to 90% and the red light, which must after all be transmitted twice through the wall of a bottle, 81% or less.

It will be apparent that, due to these colours, a great difference results, particularly in respect of the glass particle in the bottle, between the light of the blue colour and the light of the red colour, whereby a good distinction can be made between real flaws and false flaws.

Images can also be recorded with and without secondary blue lighting, whereby further filtering options become possible.

In carrousel 41 according to FIG. 4, bottles B^{II} are transferred via an infeed carousel 42 to a detection carousel 43, wherein the bottles are rotated about their longitudinal axis in the first segment I and then stopped, after which they are inspected for glass particles with cameras and illumination in the second segment and returned to the production line via an outfeed carousel 43, whereby possible bottles with ‘flaws’ can be rejected in a manner not shown. Such a system is further described in the patent literature.

In the embodiments according to FIG. 5, which are described in patent application PCT/NL2005/000565, bottles B^{III} are moved via an infeed carousel 51 to an inspection carousel 52, where they are inspected during rotation, after which they are fed back into the production line via outfeed carousel 53. In the so-called in-line inspection of FIG. 6, bottles B^{IV} are inspected by a plurality of cameras 61 around line 62, wherein the illumination provides for a so-called virtual rotation.

The method and device with the (blue) light curtain can be applied in all the above stated and similar systems. Use is preferably made here of LEDs for blue light and red light, a Firewire colour camera of 80 frames per second or more with asynchronous reset. The LEDs are preferably flashed so as to obtain a high light output, wherein a camera and the LEDs are preferably triggered by one signal. The device is further equipped with the necessary hardware and software for image storage, network, interface and the like for performing the desired hardware and software recognition.

The above mentioned light curtain is also applicable to the so-called Spin inspection and RotoCheck system and other inspection systems from Krones and others which, like the above stated systems, will hereby acquire a better performance.

In in-line inspection (FIG. 6) the bottle can be illuminated and inspected according to a number of methods, for instance

1) with the illumination from the side (FIG. 7);

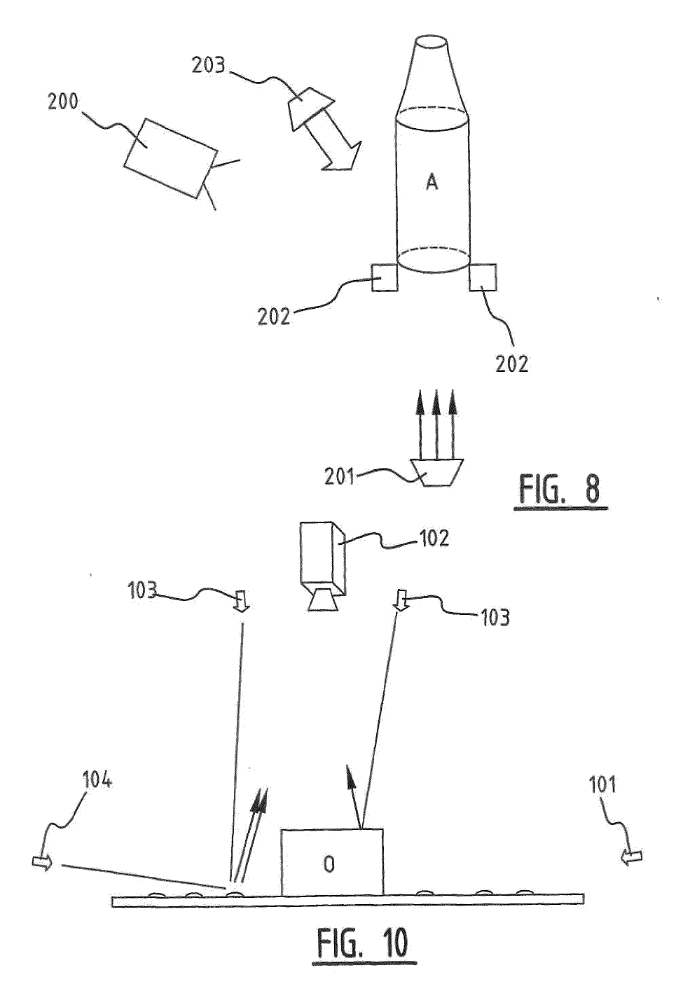

2) with the illumination from the underside (FIG. 8); and

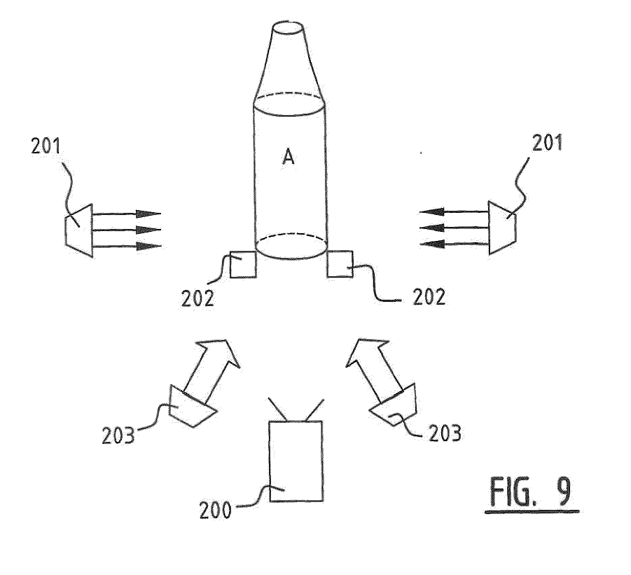

3) with the camera from the underside (FIG. 9).

Method 2) provides the option of use in combination with the spin inspection method. This method, described in patent FR 2726651, tilts the bottle from the upright position, after which the bottle is rotated at high speed about its longitudinal axis. During this rotation the content of the bottle is monitored for undesired objects which are immobile or rotate slowly in the liquid in the bottle.

The embodiment according to FIG. 10 relates for instance to the detection of objects such as boxes, suitcases, domestic pets or other moving objects on a conveyor belt 101. Using a camera 102 and schematically shown main illumination sources 103 an object can already be distinguished. By applying in this primary so-called frontal illumination secondary glancing illumination from a second light source 104, for instance with the blue colour, while the primary illumination has for instance the red colour, real and false candidates can also be better distinguished.

FIG. 11 shows a data flow diagram of a preferred embodiment of the present invention. An image from a camera (1100A, 1100B-1100N) or a combination of a plurality of images, either obtained sequentially from a single camera or obtained sequentially or in parallel from two or more cameras, are presented to the optical detection system independently of each other. Each individual camera image (1100A, 1100B-1100N) is analysed after processing and candidate flaws are selected (1102A, 1102B-1102N). This produces for each camera image (1100A, 1100B-1100N) a set of candidate flaws (1104A, 1104B-1104N). The candidate flaws of 1104A are combined in pairs with the candidate flaws (1104B-1104N) of the other camera images (1100B-1100N). The probability that the combination of candidate flaws represents a real flaw is determined on the basis of detected properties of the candidate flaws. Unlikely combinations of candidates are filtered out on the basis of this probability. For each of the potentially corresponding combinations of candidate flaws (1108A) the three-dimensional position of the candidate flaw can be established (1110A) on the basis of the mutual location. This step results in a set of candidate flaws with associated three-dimensional position (1112A). The set of candidate flaws (1112A) is filtered by removing the candidate flaws of which the three-dimensional position is not located in a predefined area (for instance inside the bottle). This eventually results in a possibly empty set of candidate flaws (1160A). If the set 1160A is empty, i.e. no flaws have been ascertained, the bottle is not removed from the process. Conversely, if the set of candidate flaws 1160A is not empty, the bottle is removed from the production line.

In the preferred embodiment of the present invention the additional information available due to the use of a second radiation source with different radiation characteristics is used in three ways:

Firstly, the false reject ratio can be improved, i.e. the number of false candidate flaws can be reduced by transforming the colour image during the optical detection (1102A) to a grey value image on the basis of a linear combination of colour channels.

Secondly, the false candidate flaws are clearly distinguished from the real candidate flaws in the camera images which are recorded with the radiation from the second illumination source. This information improves the filtering out of false candidate flaws during the combining of candidate flaws of a plurality of camera images in 1106A.

Thirdly, the additional information has a favourable effect on the classification of candidate flaws. A classification system (1180A) supports on the one hand (1140A) the selection (1102A) of candidate flaws in the optical system, and on the other hand (1142A) the filtering of potentially corresponding combinations of candidate flaws (1110A). In contrast to the first radiation source, the characteristics of the second radiation source are chosen such that false candidate flaws can be detected as well as possible and real candidate flaws to a lesser extent. This results in a strong distinguishing capacity for the purpose of the classification of false candidate flaws. Each of these three methods of use have a favourable effect on both the false reject ratio and the false reject ratio.

1. Method for detecting an undesired object or flaw in relation to a background, wherein radiation with a first characteristic is cast by a first radiation source onto and close to the background and the location where the undesired object or flaw is to be expected, wherein radiation generated by the radiation source and reflected, dispersed, diffracted or transmitted by the undesired object is sensed by one or more radiation sensors, and wherein radiation is cast onto the location by a second radiation source with a second characteristic, which is disposed and/or has a second radiation characteristic such that apparent flaws can be removed relatively easily from the image signal sensed by the sensors.

2. Method as claimed in claim 1, wherein the first radiation comprises red visible light, preferably in a wavelength range of 550-780 nm or more preferably round about 650 nm, and the second radiation is blue visible light in a wavelength range of preferably 250-450 nm.

3. Method as claimed in claim 1 or 2, wherein the undesired object is a glass splinter in a beer bottle or similar object and wherein the bottom and/or the walls of the beer bottle are formed by glass, preferably of green or brown colour.

4. Method as claimed in claim 1, 2 or 3, wherein the illumination with the second radiation characteristic is radiated as it were as a (net) curtain along the location to be detected, while the first radiation source is oriented, optionally after reflection, more at the one or more of the sensors.

5. Device for detecting an undesired object or flaw in relation to a background, comprising:
a first radiation source for casting radiation with a first characteristic onto and close to the background and the location where the undesired object or flaw is to be expected;
one or more radiation sensors for sensing the radiation generated by the first radiation source which is reflected, dispersed, diffracted and/or transmitted by the undesired object; and
a second radiation source with a second characteristic which differs from the first characteristic such that the radiation sensor in fact receives two images of the background.

6. Device as claimed in claim 5, wherein the first radiation source comprises LEDs with red light and the second radiation source comprises LEDs with blue light.

7. Device as claimed in claim 5 or 6, wherein the background comprises a conveyor and the first radiation source provides for frontal illumination of the conveyor while the second radiation source provides for glancing illumination.
